(19) United States
(12) Patent Application Publication
(10) Pub. No.: US 2021/0163858 A1
(43) Pub. Date: Jun. 3, 2021

(54) PURGE COMPOSITION AND METHOD OF CLEANING

(71) Applicants: Chem-Trend Limited Partnership, Howell, MI (US); Freudenberg SE, Weinheim (DE)

(72) Inventors: Achim Gruber, Schoenau (DE); Renee Graewe, Landshut (DE); Philipp Faber, Bopfingen (DE); Alexis Schweikert, Augsburg (DE); Karin Grasser, Fuerstenfeldbruck (DE); Verena Wagner, Hausen (DE); Thomas Galle, Maisach (DE)

(21) Appl. No.: 17/268,606

(22) PCT Filed: Aug. 17, 2018
(86) PCT No.: PCT/US2018/046962

§ 371 Date: Feb. 16, 2021

(51) Int. Cl. C11D 11/00; C11D 7/22; C11D 7/04; C11D 7/50; B29C 33/72; B08B 7/00

(52) U.S. Cl. CPC C11D 11/0041; C11D 7/22; B08B 7/0014; C11D 7/5004; B29C 33/722; C11D 7/04

(57) ABSTRACT

The invention relates to a purge composition comprising a polymer formulation which is tacky and suitable to cross-link and/or cure to become less tacky, at least 50% of solids of the polymer formulation comprising a polysiloxane, polyurethane, acrylate resin, epoxy resin, melamine resin, formaldehyde resin, or a mixture of two or more of any of these; and a curing catalyst suitable to cure the polymer formulation, wherein the composition is suitable to cross-link and/or cure at within 0.1 to 120 minutes at a temperature in a range of from 0 to 450° C. within a device into which the composition is injected. The invention also relates to a method of cleaning a material processing device.

### FIELD

The present application relates to purge compositions suitable for cleaning interior surfaces of material (e.g., polymers and polymeric materials) processing equipment and methods of using such purge compositions.

### BACKGROUND OF THE INVENTION

Mixers, compounders, extruders, and similar devices for processing (e.g., molten) polymers and other viscous substances become contaminated with residues from the processed materials, breakdown by-products, and the like. Since these devices often contain the working portions within exterior walls and/or housings, the cleaning of such devices is often complicated and laborious. For example, cleaning the barrel and other friction spaces of an extruder are well-known problems in polymer engineering.

Several approaches have been taken to address the challenges of cleaning material processing devices, including for example, burning off residues (i.e., pyrolysis), adjusting the speed, flow, and/or direction of the material streams (i.e., fluid dynamic considerations), adding canals, orienting nozzles, expanding gauge, etc. (device-design considerations), and using a purge or cleaning agent with tailored properties for abrasion, dissolution, adhesion, or otherwise (i.e., chemical/materials considerations).

Cleaning or purging compounds are employed in the cleaning or change over process with physical and/or chemical effect. Physical purge compounds are generally thermoplastics, occasionally containing abrasive materials such as diatomaceous earth, which often have a higher melting point than that of the material being purged from the equipment. Physical purge compounds operate by attempting to physically force the contaminating material out of the equipment. The effectiveness of such physical cleaners, particularly one containing an abrasive, has to be balanced against premature wear on the equipment, e.g., screw, barrel, and associated equipment. Using physical purging compounds can require large amounts of material and/or take long periods to achieve cleaning.

Another class of purging compounds include chemical purging compounds, which often attempt to break down plastic residues in the equipment. The chemical purge compounds typically contain thermoplastic resins, organic and inorganic salts, and inert materials. Typical chemical purge compounds may often require complicated operational maneuvering, e.g., starting, stopping, and heating, may also take extended lengths of time, and often off gas or emit organic vapors in operation.

Many known purge formulations require extraneous components to be effective, which the present invention may not necessarily require.

CN105924931A (Wang) describes a plastic screw cleaning agent prepared from, by mass: 100 parts thermoplastic elastomer; 40-80 parts short glass fibers; 4-8 parts of a surfactant, namely, sodium α-olefin sulfonate; 2-5 parts alkaline agent, namely, sodium silicate; and 3-5 parts lubricant. Wang's thermoplastic elastomer may be thermoplastic polyurethane elastomer (TPU), polyolefin elastomer (POE), or styrene-butadiene-styrene block copolymer (SBS).

DE 195 28 469 A1 (Winter) discloses a cleaning composition for plastic processing machines having a homogeneous mixture of a neutral polyester, e.g., a natural resin and polystyrene (PS), and pulverized wood, e.g., sawdust, which mixture is solidified, then pulverized.

JP 2007-238689 (Fujisawa) describes a cleaning agent with a vinyl polymer (A), low-molecular-weight olefin polymer (B), and lubricating agent (C) containing amide group or ester group, and/or aliphatic metal salt (D). Fujisawa's olefin polymer (A) may be a vinyl-base polymer containing an aromatic vinyl monomer, such as styrene, which may further be copolymerized with an acrylic monomer, though a graft copolymer of aromatic vinyl monomer with a rubber-like polymer, with a T_{g}≤0° C., such as polybutadiene, styrene butadiene rubber, acrylonitrile-butadiene rubber, polyisoprene, polychloroprene, block SBR, conjugated diene system rubbers, such as block styrene-isoprene rubber and ethylene-propylene-diene rubber, acrylic rubber, ethylene-propylene rubber, silicone rubber, silicon acrylic composite rubbers, polybutyl acrylate, etc.

US 2003/0221707 A1 (Blanton) is directed to a purge material of thermoplastic polymer and layered inorganic particles most suitably in the shape of plates with significantly high aspect ratio. Blanton's purge material may be any thermoplastic, vulcanizable and thermoplastic rubbers, including thermoplastic silicones such as poly(dimethyl siloxane), poly(dimethyl siloxane), poly(dimethyl siloxane co-phenylmethyl siloxane), and the like.

WO 2008/012769 A2 (King) is directed to a polymer purge composition, typically based on PVC, for purging a plastic extruder or injection molder. King's purge composition may have abrasive filler(s), detergent(s), and/or lubricant(s) and is stabilized with an organic based stabilizer (OBS), which is a 2(1H)-pyrimidinone and pyrimidinone thiocarbonyl cytosine-esque compounds with a perchlorate, glycidil, β-keto carbonyl, (poly) dihydropyridines, polyol, disaccharide alcohols, sterically hindered amine, alkali aluminosilicate, hydrotalcite, alkali aluminocarbonate, alkali/alkaline earth carboxylate, (bi)carbonate or hydroxide, antioxidants, lubricants or organotin compounds which are suitable for stabilizing chlorine-containing polymers.

JP S54-029351 (Inoue) is directed to purging compound composed of a cross-linked polyethylene resin having specific gel fraction. Inoue's purging compound uses an organic peroxide for cross-linking and appears to be cross-linked prior to purging. Inoue's resin may be a copolymer of 50% by weight or more of ethylene and vinyl monomers, such as α-olefins, such as propylene, 1-butene, and 1-pentene, and/or vinyl acetate. It is not clear whether Inoue's purging compound is cross-linked prior to purging, but Inoue's purging compound has a very small adhesion force to metal.

US 2007/0238636 A1 (Thomson) describes polymer processing equipment cleaning compositions containing thermoplastic material(s) or resin(s) and a cross-linking agent such as an organic peroxide, and optionally further fillers, blowing agents, and lubricants. Thomson's thermoplastic may be polyethylene (PE), polystyrene (PS), and/or a styrene-based thermoplastic elastomer, Thomson's organic peroxide or catalyst can be dicumyl peroxide, benzoyl peroxide, cumene hydroperoxide, tertiary butyl hydroperoxide, tertiary butyl peracetate, tertiary butyl perbenzoate, and/or di-tert-butyl azodiisobutylnitrile, and Thomson's fillers may be abrasives, e.g. CaCO₃, wollastonite, mica, feldspar, and/or glass. Thomson's composition may use a minor fraction of a lubricant such as high molecular weight silicone or fluoropolymer concentrate. Thomson exemplifies embodiments with 5-25 (or 10-15) wt. % PE, 30-60 (or 40-50) wt. % PS, 10-20 (or 10-15) wt. % styrene-based thermoplastic material, 20-40 (or 25-30) wt. % mineral filler, and 0.05-0.25 (or 0.1-0.2) wt. % crosslinking agent.

U.S. Pat. No. 4,935,175 (Kitaura) discloses an odor-free mold-cleaning composition comprising an uncured rubber composition with uncured rubber and a curing agent, and at least one removal aid having imidazoles and/or imidazolines for use in semiconductor molding systems wherein epoxy resins leave residues such as mold releasing agent (MRA). Kitaura describes that prior art introduction of thermosetting melamine resin into a mold to collect oxidized/deteriorated MRA inside a molded and cured melamine composition, and then remove the molded article has the problem of formalin and (ob)noxious odor generation.

Kitaura mentions U.S. Pat. No. 3,476,599 (Grover)'s similar use of uncured rubber with particular aminoalcohol(s) which similarly cause obnoxious odors from the aminoalcohol(s). Grover's approach uses inexpensive elastomeric rubber, such as styrene-butadiene rubber (SBR), or natural rubber, nitrile-butadiene, polybutadiene, polychloroprene, and ethylene propylene copolymer, other polymers which incompletely vulcanize, warning that an incomplete cure complicates elastomer removal from the mold at the end of the cycle. Grover may use RT curing polymers, as well as those requiring heat, and may use a non-curing polymer, e.g., a thermoplastic such as PVC, as a carrier

U.S. Pat. No. 4,670,329 (Pas) discloses depositing moldable composition on a carrier sheet to form an uncured mat for cleaning a compression, transfer, or similar mold, molding whereby the moldable composition melts and flows into conformity with the interior configuration of the mold and cures in that conforming configuration, then can be ejected as a unitary structure from the mold. Pas's moldable composition may be a melamine.

JP H08-295763 (Hanatani) describes a resin cleaning composition comprising 2 or more wt. % cross-linked olefin polymers having a degree of cross-linking, preferably polyethylene (PE) having a melt flow index (MFI) of less than or equal to 1 g/10 min, and a cross-linking olefin polymer, preferably a vinylsilane-modified olefin polymer. Hanatani's cross-linked polymer is a chemically, thermally, irradiatively, oxidatively, or otherwise cross-linked monomer having an unsaturated bond or alkoxysilane bonds, preferably on olefin polymers with vinyl or alkoxysilane group(s), for example, 1 part (wt.) polyethylene vinyltrimethoxysilane-grafted copolymer (MFI: 0.7); 1 part HDPE (MFI: 0.25); and 0.05 part dibutyltin dilaurate mixed, extruded, and granulated to prepare pellets, which cross-linked polymer serves as 25 wt. % of the cleaning composition along with 75 wt. % HDPE (MFI: 0.06) and 1 wt. % fatty amide surfactant.

Despite the current understanding of purge compositions, there remains a need for improved purge compositions and methods of cleaning. The present invention provides a purge composition comprising a polymer formulation which is tacky and suitable to cross-link and/or cure to become less tacky.

### BRIEF SUMMARY OF THE INVENTION

The invention provides a purge composition comprising a polymer formulation which is tacky and suitable to cross-link and/or cure to become less tacky, at least 50% of solids of the polymer formulation comprising a polysiloxane, polyurethane, acrylate resin, epoxy resin, melamine resin, formaldehyde resin, or a mixture of two or more of any of these; and a curing catalyst suitable to cure the polymer formulation, wherein the composition is suitable to cross-link and/or cure at within 0.1 to 120 minutes at a temperature in a range of from 0 to 450° C. within a device into which the composition is injected.

The invention also provides a method of cleaning a residue from an interior of a material processing device, the method comprising introducing a cleaning composition, in fluid form, into the interior of the device so as to at least partially take up the residue into the cleaning composition, the interior being inaccessible to an operator without at least partial disassembly; curing the cleaning composition within the interior of the device, thereby forming a thermoset material, at least partially containing the residue, within the device; and operating the device to thereby break up the thermoset material and render the thermoset material and the residue expellable from the device.

### DETAILED DESCRIPTION OF THE INVENTION

In an embodiment, the invention provides a purge composition comprising a polymer formulation which is tacky and suitable to cross-link and/or cure to become less tacky, at least 50% of solids of the polymer formulation comprising a polysiloxane, polyurethane, acrylate resin, epoxy resin, melamine resin, formaldehyde resin, or a mixture thereof; and a curing catalyst, wherein the purge composition undergoes cross-linking and/or curing within 0.1 to 120 minutes at a temperature from 0 to 450° C. within a device into which the composition is injected.

Without wishing to be bound to any particular theory, Applicants have discovered that when the inventive purge composition is introduced into the interior of a device (typically in fluid form) contaminated with one or more residues, that the purge composition can be cross-linked or cured at a site of interest within the device to form a thermoset material. It has been discovered that at least a portion of the contaminating residue is taken up by the thermoset material. The thermoset material has suitable physical properties such that the thermoset material can be expelled from the device (e.g., by resuming normal operation of the device). For example, the thermoset material can be broken up during operation of the device to expel the thermoset material containing at least a portion of the contaminating residue.

The inventive purge formulation advantageously removes 75% or more, 80% or more, 85% or more, 90% or more, 95% or more, 97.5% or more, 98% or more, 99% or more, or 99.5% or more (even to all visibly detectable) residues (e.g., from an interior surface of a material processing device), without requiring ionic species, such as, for example, organic ammonium, sulfonate and/or phosphate salt(s), and/or inorganic fluoride(s), chloride(s), bromide(s), iodide(s), carbonate(s), bicarbonate(s), sulfate(s), sulfite(s), phosphate(s), titanate(s), chromate(s), nitrate(s), and/or chlorate(s).

In addition, in some embodiments the inventive purge formulation can remove 75% or more, 80% or more, 85% or more, 90% or more, 95% or more, 97.5% or more, 98% or more, 99% or more, or 99.5% or more (even to all visibly detectable) residues (e.g., from an interior surface of a material processing device), without requiring a filler.

In some embodiments, the purge composition consists or consists essentially of a polymer formulation comprising a polysiloxane, polyurethane, acrylate resin, epoxy resin, melamine resin, formaldehyde resin, or a mixture of two or more of any of these and a curing catalyst to cure the polymer formulation.

Without “requiring X species,” e.g., without requiring ionic species, as used herein is intended to convey that the inventive composition may use less than 10 wt. %, less than 5 wt. %, less than 2.5 wt. %, less than 1 wt. %, less than 0.5 wt. %, less than 0.25 wt. %, less than 0.1 wt. %, less than 0.001 wt. % of the species “X,” which may mean adding none of that species beyond its normal contaminant level in other necessary components, or even excluding species “X.” As used herein, the term “curing” generally means cross-linking what were previously more freely flowing chains of the uncured monomeric, oligomeric and/or polymeric component(s) (referred to herein as “polymer formulation”) of the purge compound. The term “polymer formulation”, as used herein, refers to the monomeric, oligomeric, and/or polymeric components present in the polymer formulation prior to curing.

Together with, or separately from the possible avoidance of ionic compounds, the invention may be effective as a purge formulation without the use of amine-containing and/or organic solvent(s), such as those known in the art for rubber and other elastomers, i.e., any combination of alcohol(s), ether(s), ester(s), and/or aliphatic(s), which may include methanol, ethanol, propanol, isopropanol, butanol, C₅ alcohol(s), C₆ alcohol(s), C₇ alcohol(s), C₈ alcohol(s), C₉ alcohol(s), C₁₀ alcohol(s), etc., toluene, xylene(s), benzene, ethylbenzene, cumene, chlorobenzenes, hexane(s), petroleum ethers, ligroin, decane(s), kerosenes, organic oil(s) (castor, canola, soybean, palm, etc.), mineral oil(s), silicone oil(s), etc., diethyl ether, MTBE, ETBE, dioxane(s), morpholine, THF, THP, cyclopentyl methyl ether, di-tert-butyl ether, dibutyl ether, diisopropyl ether, dimethoxyethane, dimethoxymethane, methoxyethane, 2-(2-methoxyethoxy)ethanol, 2-methyl-THF, PEG(s), 2,2,5,5-tetramethyl-THF, etc., ethyl acetate, n-butyl acetate, amyl acetate, isobutyl acetate, isopropyl acetate, n-propyl acetate, n-butyl propionate, n-pentyl propionate, n-propyl propionate, etc., acetone, MEK, isophorone, di-isobutyl ketone, methyl isobutyl ketone, etc. In addition to or separately from these organic solvents, the invention may avoid amine solvents. The avoidable amine-containing rubber solvent compound(s) according to the invention may be aminoalcohol(s), e.g., as set forth in Grover, imidazole(s) and/or imidazoline(s), e.g., as set forth in Kitaura, pyridine(s), etc.

Together with, or separately from the possible avoidance of ionic compounds and/or solvents, the invention may be effective as a purge formulation without the use of surfactants. Classes of surfactants which may be avoided by the inventive purge composition include polyalkylene oxide-based (PEG, PPO, PPG, poly-THF, etc.) polyol surfactant(s), alkyl sulfonate salt(s), alkyl sulfate salt(s), alkaryl sulfonate salt(s), e.g., neutral alkylbenzenesulfonate salt(s), alkaryl sulfate salt(s), C₆₋₃₆ carboxylic acid salt(s), polyethylene glycol fatty acid wax(es), and/or polyethylene glycol fatty acid amide wax(es).

Together with, or separately from the possible avoidance of ionic compounds, solvents, and/or surfactants, the invention may be effective as a purge formulation without the use of blowing agent(s). Blowing agents, which may be excluded from the inventive purge composition, when activated, evolve or produce gas, such as N₂ or CO₂. The blowing agent(s) excludable without diminishing the effect of the invention may be N₂, CO₂, or air directly, or carbonate(s), bicarbonate(s), azo compound(s), NaHCO3, KHCO₃, (NH₄)₂CO₃, polycarbonic acids, methyl chloride, ethyl chloride, pentane, isopentane, F₄C, ClF₃C, Cl₂F₂C, C₃FC, F₆C₂, 1-chloro-1,1-difluoro-ethane, chloro-pentafluoroethane, dichloro tetrafluoro ethane, trichloroethane, F₈C₃, heptafluoro-chloro-propane, dichloro-hexafluoro-propane nitrile, F₁₀C₄, chloro nonafluoro-butane, perfluoro-cyclobutane, azodicarbonamide (ADCA, azo(bis)formamide), α,α-azo-bis-isobutyronitrile (AIBN), benzene sulfone hydrazide, 4,4-oxy-benzene sulfonyl-semicarbazide, p-toluene sulfonyl semicarbazide, azo-dicarboxylate salt(s) (e.g., Ba), N,N′-dimethyl-N,N′-di-nitroso-terephthalamide, citric acid, azo-dicarbonamides, oxy-bis-benezenesulfonyl-hydrazide (OBSH), toluenesulfonyl-hydrazides (TSH), 5-phenyltetrazole (5-P1), di-iso-propylhydrazo-dicarboxylate (DIHC), and/or di-nitroso-pentamethylenetetramine (DNPT).

Together with, or separately from the possible avoidance of ionic compounds, solvents, surfactants, and/or blowing agents, the invention may be effective as a purge formulation without the use of sulfur, e.g., for organic rubbers. Moreover, the inventive purge composition may be effective as a purge formulation without the use of organic based stabilizers, which can include certain 2(1H)-pyrimidinone and pyrimidinone thiocarbonyl cytosine-esque compounds, such as those described in King (WO 2008/012769 A2).

Together with, or separately from the possible avoidance of ionic compounds, solvents, surfactants, blowing agents, vulcanizing sulfur, and/or organic based stabilizers, the invention may be effective as a purge formulation without the use of abrasive(s), such as ceramics, e.g., nitride(s), carbide(s), boride(s), and the like, glass, quartz, and/or metal fibers or particles, high Tg/MP polymer particles (e.g., hard acrylate resins), and/or inorganic salt particles, such as CaCO₃, Ca₃(PO₄)₂, Ca(SiO₄)₂, Al(SiO₄)₃, SiO₂, TiO₂, MgCO₃, MgO, CaO, ZnO, Al₂O₃, ZnS, Na₂SO₄, NaHSO₄, K₂SO₄, MgSO₄, CaSO₄, BaSO₄, Al₂(SO₄)₃, Na₃PO₄, Na₂HPO₄, Mg₃(PO₄)₂, AlPO₄, NaSiO₄, Mg(SiO₄)₂, K₂TiO₃, Na₂CO₃, K₂CO₃, Mg(OH)₂, Ca(OH)₂, Al(OH)₃, hydrotalcite(s), diatomaceous earth, gypsum, zeolite(s), pumice, volcanic ash, mica, and/or feldspar. Certain abrasives listed may overlap in function with blowing agents, as will be apparent to those of skill in the art.

In some embodiments, the polymer formulation comprises one or more filler(s). Typically, one or more fillers (when present) are added to modify one or more properties of the polymer formulation and/or cost as desired. As understood, suitable fillers include, for example, calcium carbonate (e.g., ground calcium carbonate or precipitated calcium carbonate), wood flour, saw dust, and the like. By way of example, the inventive polymer formulation may comprise one or more fillers to facilitate the formation of the thermoset material thereby aiding the removal of the contaminant-containing thermoset material from a device, as described herein.

In some embodiments, the polymer formulation does not comprise a filler.

The unfilled polymer formulation can have any suitable initial viscosity, such that the initial viscosity of the unfilled polymer formulation is selected to allow the desired flow and penetration into the device to be cleaned, and/or the desired adhesion or abstraction of contaminant residues sought to be removed from the device, as discussed herein. Typically, the initial viscosity of the unfilled polymer formulation can be, e.g., as listed in Table 1 below.

As depicted in Table 1, an “X” represents a range “from [corresponding value in first row] to [corresponding value in first column],” with units in Pa·s, i.e., 1000 mPa·s, at 25° C. For example, the first “X” (top left) in Table 1 represents an embodiment of the inventive purge composition wherein the initial viscosity value of the unfilled polymer formulation is “from 1 Pa·s to 17.5 Pa·s.” Similarly, the first two “X”s in the second row of Table 1 are meant to convey that embodiments of the inventive purge composition can have an unfilled polymer formulation having an initial viscosity from 1 Pa·s to 20 Pa·s and/or from 2.5 Pa·s to 20 Pa·s.

Moreover, the unfilled polymer formulation can have an initial viscosity of 1 Pa·s or more, for example, 2.5 Pa·s or more, 5 Pa·s or more, 7.5 Pa·s or more, 8.75 Pa·s or more, 10 Pa·s or more, 11.25 Pa·s or more, 12.5 Pa·s or more, 13.75 Pa·s or more, or 15 Pa·s or more. Alternatively, or in addition, the unfilled polymer formulation can have an initial viscosity of 50 Pa·s or less, for example, 45 Pa·s or less, 40 Pa·s or less, 35 Pa·s or less, 30 Pa·s or less, 27.5 Pa·s or less, 25 Pa·s or less, 22.5 Pa·s or less, 20 Pa·s or less, or 17.5 Pa·s or less. Thus, the unfilled polymer formulation can have an initial viscosity in a range bounded by any two of the aforementioned endpoints, for example, from 1 Pa·s to 50 Pa·s, and the like.

TABLE 1
Initial viscosity of the unfilled polymer formulation (25° C.)

| (Pa · s) | 1 | 2.5 | 5 | 7.5 | 8.75 | 10 | 11.25 | 12.5 | 13.75 | 15 |
|---|---|---|---|---|---|---|---|---|---|---|
| 17.5 | X | X | X | X | X | X | X | X | X | X |
| 20 | X | X | X | X | X | X | X | X | X | X |
| 22.5 | X | X | X | X | X | X | X | X | X | X |
| 25 | X | X | X | X | X | X | X | X | X | X |
| 27.5 | X | X | X | X | X | X | X | X | X | X |
| 30 | X | X | X | X | X | X | X | X | X | X |
| 35 | X | X | X | X | X | X | X | X | X | X |
| 40 | X | X | X | X | X | X | X | X | X | X |
| 45 | X | X | X | X | X | X | X | X | X | X |
| 50 | X | X | X | X | X | X | X | X | X | X |

As noted, the initial oligo-polymeric formulation, before curing and/or cross-linking, may also be filled. The viscosity of the polymer formulation, when filled, is selected in the same manner as the unfilled initial polymer formulation, as discussed herein. Typically, the viscosity of the filled initial oligo-polymeric formulation can be, e.g., as listed in Table 2 below.

As depicted in Table 2, an “X” represents a range “from [corresponding value in first row] to [corresponding value in first column],” with units in Pa·s, i.e., 1000 mPa·s, at 25° C. For example, the first “X” (top left) in Table 2 represents an embodiment of the inventive purge composition wherein the viscosity value of the filled polymer formulation is “from 17.5 Pas to 25 Pa·s.” Similarly, the first two “X”s in the second row of Table 2 are meant to convey that embodiments of the inventive purge composition can have a filled polymer formulation having a viscosity from 17.5 Pa·s to 30 Pa·s and/or from 20 Pas to 30 Pa·s.

Moreover, the filled polymer formulation can have a viscosity of 17.5 Pa·s or more, for example, 20 Pa·s or more, 22.5 Pa·s or more, 25 Pa·s or more, 27.5 Pa·s or more, 30 Pa·s or more, 32.5 Pa·s or more, 35 Pa·s or more, 37.5 Pa·s or more, or 40 Pa·s or more. Alternatively, or in addition, the filled polymer formulation can have a viscosity of 75 Pa·s or less, for example, 65 Pa·s or less, 60 Pa·s or less, 55 Pa·s or less, 50 Pa·s or less, 45 Pa·s or less, 40 Pa·s or less, 35 Pa·s or less, 30 Pa·s or less, or 25 Pa·s or less. Thus, the filled polymer formulation can have a viscosity bounded by any two of the aforementioned endpoints, for example from 17.5 Pas to 75 Pa·s, and the like.

TABLE 2
Viscosity of the initial oligo-polymeric formulation (25° C.)

| (Pa · s) | 17.5 | 20 | 22.5 | 25 | 27.5 | 30 | 32.5 | 35 | 37.5 | 40 |
|---|---|---|---|---|---|---|---|---|---|---|
| 25 | X | X | X | | | | | | | |
| 30 | X | X | X | X | X | | | | | |
| 35 | X | X | X | X | X | X | X | | | |
| 40 | X | X | X | X | X | X | X | X | X | |
| 45 | X | X | X | X | X | X | X | X | X | X |
| 50 | X | X | X | X | X | X | X | X | X | X |
| 55 | X | X | X | X | X | X | X | X | X | X |
| 60 | X | X | X | X | X | X | X | X | X | X |
| 65 | X | X | X | X | X | X | X | X | X | X |
| 75 | X | X | X | X | X | X | X | X | X | X |

The viscosity of the cured, filled polymer formulation can have any suitable viscosity such that the viscosity of the cured, filled polymer formulation is selected to allow sufficient solidity of the cured solid to be broken up in the device to be cleaned, rather than just elastically stretched, balanced against the ability of the device to break up the solid, and/or the desired adhesion or abstraction of contaminant residues sought to be removed from the device, as discussed herein. Typically, the post-curing viscosity can be, e.g., as listed in Table 3 below.

As depicted in Table 3, an “X” represents a range “from [corresponding value in first row] to [corresponding value in first column],” with units in kPa·s, i.e., 1000 Pas at 25° C. For example, the first “X” (top left) in Table 3 represents an embodiment of the inventive purge composition wherein the post-cure viscosity of the filled polymer formulation s “from 1 kPa·s to 100 kPa·s.” Similarly, the first two “X”s in the second row of Table 3 are meant to convey that embodiments of the inventive purge composition can have a filled polymer formulation having a post-cure viscosity from 1 kPa·s to 150 kPa·s and/or from 10 kPa·s to 150 kPa·s.

Moreover, the filled polymer formulation can have a post-cure viscosity of 1 kPa·s or more, for example, 10 kPa·s or more, 12.5 kPa·s or more, 25 kPa·s or more, 37.5 kPa·s or more, 50 kPa·s or more, 62.5 kPa·s or more, 75 kPa·s or more, 87.5 kPa·s or more, or 100 kPa·s or more. Alternatively, or in addition, the filled polymer formulation can have a viscosity of 1000 kPa·s or less, for example, 875 kPa·s or less, 750 kPa·s or less, 625 kPa·s or less, 500 kPa·s or less, 375 kPa·s or less, 250 kPa·s or less, 200 kPa·s or less, 150 kPa·s or less, or 125 kPa·s or less. Thus, the filled polymer formulation can have a post-cure viscosity bounded by any two of the aforementioned endpoints, for example, from 1 kPa·s to 1000 kPa·s, and the like.

TABLE 3
Post-cure viscosity of filled polymer formulation (25° C.)

| (kPa · s) | 1 | 10 | 12.5 | 25 | 37.5 | 50 | 62.5 | 75 | 87.5 | 100 |
|---|---|---|---|---|---|---|---|---|---|---|
| 125 | X | X | X | X | X | X | X | X | X | X |
| 150 | X | X | X | X | X | X | X | X | X | X |
| 200 | X | X | X | X | X | X | X | X | X | X |
| 250 | X | X | X | X | X | X | X | X | X | X |
| 375 | X | X | X | X | X | X | X | X | X | X |
| 500 | X | X | X | X | X | X | X | X | X | X |
| 625 | X | X | X | X | X | X | X | X | X | X |
| 750 | X | X | X | X | X | X | X | X | X | X |
| 875 | X | X | X | X | X | X | X | X | X | X |
| 1000 | X | X | X | X | X | X | X | X | X | X |

The uncured polymeric components can have any suitable number average molecular weight, such that the initial polymer formulation is suitably fluid and suitably tacky. The number average molecular weight, Mₙ, of an uncured polymer, e.g., polysiloxane(s), polyurethane(s), acrylate resin(s), epoxy resin(s), melamine resin(s), and/or formaldehyde resin(s), especially polysiloxane(s), useful in the invention may range broadly, as long as the initial formulation is sufficiently fluid and sufficiently tacky, the fluidity/tackiness potentially varying based upon application, and the cured formulation has an appropriate hardness to allow fracture and expulsion. Typically, the Mₙ of the uncured polymer formulation can be, e.g., as listed in Table 4 below.

As depicted in Table 4, an “X” represents a range “from [corresponding value in first row] to [corresponding value in first column],” with units in kDa, i.e., 1000 g/mol. For example, the first “X” (top left) in Table 4 represents an embodiment of the inventive purge composition wherein the number average molecular weight of the uncured polymer formulation is “from 2.5 kDa to 7.5 kDa.” Similarly, the first two “X”s in the second row of Table 4 are meant to convey that embodiments of the inventive purge composition can have an uncured polymer formulation having a number average molecular weight of from 2.5 kDa to 10 kDa and/or from 5 kDa to 10 kDa.

Moreover, the uncured polymer formulation can have a number average molecular weight of 2.5 kDa or more, for example, 5 kDa or more, 6.25 kDa or more, 7.5 kDa or more, 8.75 kDa or more, 10 kDa or more, 11.25 kDa or more, 12.5 kDa or more, 13.75 kDa or more, or 15 kDa or more. Alternatively, or in addition, the uncured polymeric component(s) of the polymer formulation can have a number average molecular weight of 25 kDa or less, for example, 22.5 kDa or less, 20 kDa or less, 18.75 kDa or less, 17.5 kDa or less, 16.25 kDa or less, 15 kDa or less, 12.5 kDa or less, 10 kDa or less, or 7.5 kDa or less. Thus, the uncured polymeric component(s) of the polymer formulation can have a number average molecular weight bounded by any two of the aforementioned endpoints, for example from 2.5 kDa to 25 kDa, and the like.

TABLE 4
Mₙ of uncured polymer formulation

| (kDa) | 2.5 | 5 | 6.25 | 7.5 | 8.75 | 10 | 11.25 | 12.5 | 13.75 | 15 |
|---|---|---|---|---|---|---|---|---|---|---|
| 7.5 | X | X | X | | | | | | | |
| 10 | X | X | X | X | X | | | | | |
| 12.5 | X | X | X | X | X | X | X | | | |
| 15 | X | X | X | X | X | X | X | X | X | |
| 16.25 | X | X | X | X | X | X | X | X | X | X |
| 17.5 | X | X | X | X | X | X | X | X | X | X |
| 18.75 | X | X | X | X | X | X | X | X | X | X |
| 20 | X | X | X | X | X | X | X | X | X | X |
| 22.5 | X | X | X | X | X | X | X | X | X | X |
| 25 | X | X | X | X | X | X | X | X | X | X |

The uncured polymeric components can have any suitable weight average molecular weight, such that the initial polymer formulation is suitably fluid and suitably tacky. The weight average molecular weight, M_{w}, of an uncured polymer, e.g., polysiloxane(s), polyurethane(s), acrylate resin(s), epoxy resin(s), melamine resin(s), and/or formaldehyde resin(s), especially polysiloxane(s), useful in the invention may range broadly, as long as the initial polymer formulation is sufficiently fluid and sufficiently tacky, the fluidity/tackiness potentially varying based upon application, and the cured formulation has an appropriate hardness to allow fracture and expulsion. Typically, the M_{w} can be, e.g., as listed in Table 5 below.

As depicted in Table 5, the first “X” (top left) in Table 5 represents an embodiment of the inventive purge composition wherein the weight average molecular weight of the uncured polymeric component(s) of the polymer formulation is “from 5 kDa to 17.5 kDa.” Similarly, the first two “X”s in the second row of “Table 5 are meant to convey that embodiments of the inventive purge composition can have the uncured polymeric component(s) of the polymer formulation having a weight average molecular weight of from 5 kDa to 20 kDa and/or from 7.5 kDa to 20 kDa.

Moreover, the uncured polymer formulation can have a weight average molecular weight of 5 kDa or more, for example, 7.5 kDa or more, 10 kDa or more, 12.5 kDa or more, 15 kDa or more, 17.5 kDa or more, 20 kDa or more, 22.5 kDa or more, 25 kDa or more, or 27.5 kDa or more. Alternatively, or in addition, the uncured polymeric component(s) of the polymer formulation can have a weight average molecular weight of 50 kDa or less, for example, 45 kDa or less, 42.5 kDa or less, 40 kDa or less, 37.5 kDa or less, 35 kDa or less, 32.5 kDa or less, 25 kDa or less, 20 kDa or less, or 17.5 kDa or less. Thus, the uncured polymeric component(s) of the polymer formulation can have a weight average molecular weight bounded by any two of the aforementioned endpoints, for example, from 5 kDa to 50 kDa, and the like.

TABLE 5
M_{w} uncured polymer formulation

| (M_{w}) | 5 | 7.5 | 10 | 12.5 | 15 | 17.5 | 20 | 22.5 | 25 | 27.5 |
|---|---|---|---|---|---|---|---|---|---|---|
| 17.5 | X | X | X | X | X | | | | | |
| 20 | X | X | X | X | X | X | | | | |
| 25 | X | X | X | X | X | X | X | X | | |
| 32.5 | X | X | X | X | X | X | X | X | X | X |
| 35 | X | X | X | X | X | X | X | X | X | X |
| 37.5 | X | X | X | X | X | X | X | X | X | X |
| 40 | X | X | X | X | X | X | X | X | X | X |
| 42.5 | X | X | X | X | X | X | X | X | X | X |
| 45 | X | X | X | X | X | X | X | X | X | X |
| 50 | X | X | X | X | X | X | X | X | X | X |

In keeping with an aspect of the invention, the M_{w} and Mₙ can be determined using any suitable method, for example, by size-exclusion chromatography (SEC) or gel-permeation chromatography (GCC) in a suitable solvent/eluant (e.g., toluene) with a suitable column and elution conditions and detector (e.g., Mini_10e4+500+100 column at 45° C. with a flow rate of 030 m/min and a pressure of 53.3 bar, using a refractive index detector).

The “polydispersity index,” PDI (i.e., M_{w}/Mₙ) of an uncured polymeric composition of the polymer formulation, e.g., polyurethane, acrylate resin, epoxy resin, melamine resin, and/or formaldehyde resin(s), esp. polysiloxane, useful in the invention may range broadly, as long as the initial formulation is sufficiently fluid and sufficiently tacky, the fluidity/tackiness potentially varying based upon application, and the cured formulation has an appropriate hardness to allow fracture and expulsion. Typically, the PDI of the uncured polymer can be, e.g., as listed in Table 6 below.

As depicted in Table 6, an “X” represents a unitless range “from [corresponding value in first row] to [corresponding value in first column].” For example, the first “X” (top left) in Table 6 represents an embodiment of the inventive purge composition wherein the PDI of the uncured polymeric component(s) of the polymer formulation is “from 1.5 to 2.” Similarly, the first two “X”s in the second row of Table 6 are meant to convey that embodiments of the inventive purge composition can have the uncured polymeric component(s) of the polymer formulation having a PDI of from 1.5 to 2.25 and/or from 1.75 to 2.25.

Moreover, the uncured polymeric component(s) of the polymer formulation can have a PDI of 1.5 or more, for example, 1.75 or more, 1.875 or more, 2.0 or more, 2.125 or more, 2.25 or more, 2.375 or more, 2.5 or more, 2.625 or more, or 2.75 or more. Alternatively, or in addition, the uncured polymeric component(s) of the polymer formulation can have a PDI of 4.5 or less, for example, 4.25 or less, 4 or less, 3.75 or less, 3.5 or less, 3 or less, 2.75 or less, 2.5 or less, 2.25 or less, or 2 or less. Thus, the uncured polymeric component(s) of the polymer formulation can have a PDI bounded by any two of the aforementioned endpoints, for example from 1.5 to 4.5, and the like.

TABLE 6
PDI of uncured polymeric component(s)

| (M_{w}/ | | | | | | | | | | |
|---|---|---|---|---|---|---|---|---|---|---|
| Mₙ) | 1.5 | 1.75 | 1.875 | 2.0 | 2.125 | 2.25 | 2.375 | 2.5 | 2.625 | 2.75 |
| 2 | X | X | X | | | | | | | |
| 2.25 | X | X | X | X | X | | | | | |
| 2.5 | X | X | X | X | X | X | X | | | |
| 2.75 | X | X | X | X | X | X | X | X | X | |
| 3 | X | X | X | X | X | X | X | X | X | X |
| 3.5 | X | X | X | X | X | X | X | X | X | X |
| 3.75 | X | X | X | X | X | X | X | X | X | X |
| 4 | X | X | X | X | X | X | X | X | X | X |
| 4.25 | X | X | X | X | X | X | X | X | X | X |
| 4.5 | X | X | X | X | X | X | X | X | X | X |

The amount of the polymer formulation (or its individual component(s)) in the inventive purge composition, as a proportion of the total composition weight, is selected for the same criteria as indicated for viscosities, and generally in correspondence with the viscosity properties. Typically, the amount of the polymer formulation (or its individual component(s)) in the inventive purge composition can be, e.g., as listed in Table 7 below.

As depicted in Table 7, an “X” represents a range “from [corresponding value in first row] to [corresponding value in first column],” with units in weight percent, i.e., wt. %, based upon total composition weight. For example, the first “X” (top left) in Table 7 represents an embodiment of the inventive purge composition wherein the amount of the polymer formulation in the inventive purge composition is “from 10 wt. % to 30 wt. %.” Similarly, the first two “X”s in the second row of Table 7 are meant to convey that embodiments of the inventive purge composition can have an inventive purge composition having an amount of the polymer formulation from 10 wt. % to 35 wt. % and/or from 15 wt. % to 35 wt. %.

Moreover, the inventive purge composition can have an amount of the polymer formulation of 10 wt. % or more, for example, 15 wt. % or more, 20 wt. % or more, 25 wt. % or more, 30 wt. % or more, 35 wt. % or more, 40 wt. % or more, 45 wt. % or more, 50 wt. % or more, or 55 wt. % or more. Alternatively, or in addition, the inventive purge composition can have an amount of the polymer formulation of 75 wt. % or less, for example, 70 wt. % or less, 65 wt. % or less, 60 wt. % or less, 55 wt. % or less, 50 wt. % or less, 45 wt. % or less, 40 wt. % or less, 35 wt. % or less, or 30 wt. % or less. Thus, the inventive purge composition can have an amount of the polymer formulation bounded by any two of the aforementioned endpoints, for example, from 10 to 75 wt. %, and the like.

TABLE 7
Amount of polymer formulation

| (wt. %) | 10 | 15 | 20 | 25 | 30 | 35 | 40 | 45 | 50 | 55 |
|---|---|---|---|---|---|---|---|---|---|---|
| 30 | X | X | X | X | | | | | | |
| 35 | X | X | X | X | X | | | | | |
| 40 | X | X | X | X | X | X | | | | |
| 45 | X | X | X | X | X | X | X | | | |
| 50 | X | X | X | X | X | X | X | X | | |
| 55 | X | X | X | X | X | X | X | X | X | |
| 60 | X | X | X | X | X | X | X | X | X | X |
| 65 | X | X | X | X | X | X | X | X | X | X |
| 70 | X | X | X | X | X | X | X | X | X | X |
| 75 | X | X | X | X | X | X | X | X | X | X |

The inventive purge composition may be effective without requiring particular polymer classes common in the art of purge compositions. For example, the present invention can be effective without requiring polyolefin(s) (PE, PP, LDPE, MDPE, LLDPE, and/or PS), polyvinylhalide(s) such as PVC, boron-esters and polymers, polyvinyl alcohol(s), polyvinyl acetate(s), polyimide(s), polyamide(s), polyester(s), polycarbonate(s), polyarylene(s), polyarylene ether(s), fluoropolymer(s), polyalkyleneoxide(s), and/or latex(es) including copolymer(s), graft copolymers, terpolymer(s), including ABS, SAN, etc., and the like including more than 50, 60, 75, or 80% of these classes of polymers. Generally, the inventive purge compositions employ polysiloxane(s), polyurethane(s), acrylate resin(s), epoxy resin(s), melamine resin(s), and/or formaldehyde resin(s).

In an embodiment, the purge composition comprises a polymer formulation comprising a polysiloxane.

In another embodiment, the purge composition consists essentially of, or consists of a polymer formulation comprising a polysiloxane.

Notwithstanding the ability of purge compounds according to the invention to exclude abrasives, inventive compositions may include non-abrasive fillers (flow aids), including clay(s), such as sepiolite, attapulgite, bentonites, saponite nentronite, montmorillonites, kaolin, bentonite, and/or perlite, and optionally talc, silica, and/or wollastonite, wherein the particle size and/or morphology is selected for ease of flow rather than abrasiveness. For example, the invention may use a filler, e.g., silica and/or kaolin, i.e., Al₂Si₂O₅(OH)₄ or Al₂O₃.2SiO₂.2H₂O, which is layered silicate mineral, with one tetrahedral sheet of silica (SiO₄) linked through oxygen atoms to one octahedral sheet of alumina (Al₂O₆) octahedral.

The amount of filler(s) in a purge composition according to the invention, as a proportion of the total composition, is selected to ensure desired flow and/or to ensure surface coating balance against the goal of adsorbing and/or taking up residues intended to be cleaned. The amount of filler(s), as a proportion of the total composition, is likewise selected for the same criteria as indicated for viscosities, and generally in correspondence with the viscosity properties. Typically, the amount of filler(s) in the inventive purge composition can be, e.g., as listed in Table 8 below.

As depicted in Table 8, an “X” represents a range “from [corresponding value in first row] to [corresponding value in first column],” with units in weight percent, i.e., wt. %, based upon total composition weight. For example, the first “X” (top left) in Table 8 represents an embodiment of the inventive purge composition wherein the amount of filler is “from 10 wt. % to 30 wt. %.” Similarly, the first two “X”s in the second row of Table 8 are meant to convey that embodiments of the inventive purge composition can have an amount of filler of from 10 wt. % to 35 wt. % and/or from 15 wt. % to 35 wt. %.

Moreover, the purge composition can have an amount of filler of 10 wt. % or more, for example, 15 wt. % or more, 20 wt. % or more, 25 wt. % or more, 30 wt. % or more, 35 wt. % or more, 40 wt. % or more, 45 wt. % or more, 50 wt. % or more, or 55 wt. % or more. Alternatively, or in addition, the purge composition can have an amount of filler of 75 wt. % or less, for example, 70 wt. % or less, 65 wt. % or less, 60 wt. % or less, 55 wt. % or less, 50 wt. % or less, 45 wt. % or less, 40 wt. % or less, 35 wt. % or less, or 30 wt. % or less. Thus, the purge composition can have an amount of filler bounded by any two of the aforementioned endpoints, for example from 10 to 75 wt. %, and the like.

TABLE 8
Amount of filler

| (wt. %) | 10 | 15 | 20 | 25 | 30 | 35 | 40 | 45 | 50 | 55 |
|---|---|---|---|---|---|---|---|---|---|---|
| 30 | X | X | X | X | | | | | | |
| 35 | X | X | X | X | X | | | | | |
| 40 | X | X | X | X | X | X | | | | |
| 45 | X | X | X | X | X | X | X | | | |
| 50 | X | X | X | X | X | X | X | X | | |
| 55 | X | X | X | X | X | X | X | X | X | |
| 60 | X | X | X | X | X | X | X | X | X | X |
| 65 | X | X | X | X | X | X | X | X | X | X |
| 70 | X | X | X | X | X | X | X | X | X | X |
| 75 | X | X | X | X | X | X | X | X | X | X |

According to the invention, and depending upon the monomeric, oligomeric, and/or polymeric components present prior to curing, referred to herein as “polymer formulation,” the purge composition may include one or more curing catalysts. The one or more curing catalyst is selected to facilitate the curing the components of the polymer formulation to form a thermoset material. Typically, the one or more curing catalysts comprises a platinum-containing catalyst, an organotin catalyst, a peroxide catalyst, and/or a melamine and epoxy catalyst.

Suitable platinum-containing catalysts include, for example, nitrogen-containing platinum complexes, effective at elevated temperatures, such as Pt-complexes with pyridine, benzonitrile, and/or benzotriazole, or platinum-cyclovinylmethyl-siloxane, platinum divinyltetramethyldisiloxane, platinum-octanal/octanol, platinum-carbonyl cyclovinylmethyl-siloxane, chloroplatinic acid, and the like, generally belonging to the class of Pt catalysts useful for addition curing for polymer component(s) with, e.g., vinyl/olefinic groups and Si—H groups.

Suitable organotin curing catalysts include, for example, [diacetatoxy or dicarboxylate] (RTV-2 rubber: dioctyl tin diacetylacetonate (DOTDAA), dibutyl butoxy tin chloride, dimethyl tin dineodecanoate, dioctyl tin bis-(2-ethylhexyl)maleate, tetramethyl tin, dibutyl tin dilaurate, and/or dibutyltin octanoate, and the like, generally belonging to the class of Sn catalysts useful for condensation curing of polymer component(s) with silicic acid esters and α,ω-dihydroxypolydimethylsiloxanes.

Suitable peroxide catalysts include, for example, dicumyl peroxide, benzoyl peroxide, cumene hydroperoxide, tertiary butyl hydroperoxide, tertiary butyl peracetate, and/or tertiary butyl perbenzoate, or otherwise peroxide catalysts useful for polymer component(s) with vinyl/olefinic groups.

Suitable melamine and epoxy catalysts include, for example, zeolite(s), active aluminum oxide(s), amino acid(s), polyfunctional amine(s), such as triethylenetetramine, N,N-dimethyldipropylenetriamine (DMDPTA or DMPAPA), benzyldimethylamine (BDMA), triethanolamine, and tris-(dimethylaminomethyl) phenol, acid(s), such as BF3 species, acid anhydride(s), phenol(s), such as nonyl phenol isomers, alcohol(s), such as amino-n-propyldiethanolamine (APDEA), and/or thiol(s) known in the art for accelerating epoxy and/or melamine curing.

The amount of catalyst(s) in a purge composition according to the invention, as a proportion of the total composition, is selected to ensure desired dwell time, extent of cross-linking, and/or cure temperature. The amount of catalyst(s), as a proportion of the total composition, is likewise selected for the same criteria as indicated for viscosities, and generally in correspondence with the viscosity properties. Typically, the amount of catalyst(s), as a proportion of the total composition, in the inventive purge composition can be, e.g., as listed in Table 9 below.

As depicted in Table 9, an “X” represents a range “from [corresponding value in first row] to [corresponding value in first column],” with units in weight percent, i.e., wt. %, based upon total composition weight. For example, the first “X” (top left) in Table 9 represents an embodiment of the inventive purge composition, before curing, wherein the amount of catalyst(s), as a proportion of the total composition, is “from 0.5 wt. % to 2.5 wt. %.” Similarly, the first two “X”s in the second row of Table 9 are meant to convey that embodiments of the inventive purge composition, before curing, can have an amount of catalyst(s), as a proportion of the total composition, of from 0.5 wt. % to 5 wt. % and/or from 1 wt. % to 5 wt. %.

Moreover, the purge composition, before curing, can have an amount of catalyst(s), as a proportion of the total composition, of 0.5 wt. % or more, for example, 1 wt. % or more, 1.5 wt. % or more, 2 wt. % or more, 2.5 wt. % or more, 3 wt. % or more, 3.5 wt. % or more, 4 wt. % or more, 4.5 wt. % or more, or 5 wt. % or more. Alternatively, or in addition, the purge composition, before curing, can have an amount of catalyst(s) as a proportion of the total composition, of 20 wt. % or less, for example, 15 wt. % or less, 12.5 wt. % or less, 11.25 wt. % or less, 10 wt. % or less, 8.75 wt. % or less, 7.5 wt. % or less, 6.25 wt. % or less, 5 wt. % or less, or 2.5 wt. % or less. Thus, the purge composition, before curing, can have an amount of catalyst(s), as a proportion of the total composition, bounded by any two of the aforementioned endpoints, for example, from 0.5 to 20 wt. %, and the like.

TABLE 9
Amount of catalyst(s)

| (wt. %) | 0.5 | 1 | 1.5 | 2 | 2.5 | 3 | 3.5 | 4 | 4.5 | 5 |
|---|---|---|---|---|---|---|---|---|---|---|
| 2.5 | X | X | X | X | | | | | | |
| 5 | X | X | X | X | X | X | X | X | X | |
| 6.25 | X | X | X | X | X | X | X | X | X | X |
| 7.5 | X | X | X | X | X | X | X | X | X | X |
| 8.75 | X | X | X | X | X | X | X | X | X | X |
| 10 | X | X | X | X | X | X | X | X | X | X |
| 11.25 | X | X | X | X | X | X | X | X | X | X |
| 12.5 | X | X | X | X | X | X | X | X | X | X |
| 15 | X | X | X | X | X | X | X | X | X | X |
| 20 | X | X | X | X | X | X | X | X | X | X |

As described herein, the polymer formulation comprises a polysiloxane. In an embodiment, the polysiloxane has the following structure:

A-[—SiR¹R²—O—]ₙ-[—SiR³R⁴—O—]ₘ—B,
wherein A and B may independently be H, HO—, C₁₋₆ alkoxy- (or C₁, C₂, C₃, C₄, or C₅ alkoxy-), vinyl-, vinyloxy-, (R³)₃—Si— wherein R³ is C₁₋₆ alkyl (or C₁, C₂, C₃, C₄, or C₅ alkyl-), Cl, H₂N(CH₂)ₐ— wherein a is 0-25 (or 1-20, 1-16, 1-12, 1-10, or 0, 1, 2, 3, 4, 5, 6, 7, or 8), glycidyl-, diglycidyl, or CH₃(CH₂)_{b}CO₂— wherein b is 0-20 (or 0-16, 0-12, 0-10, or 0, 1, 2, 3, 4, 5, 6, 7, or 8), and B is C₁₋₆ alkyl,
each of R¹, R², R³, and R⁴ are independently C₁₋₁₂ alkyl (or C₁, C₂, C₃, C₄, C₅, C₆, C₇, C₈, C₉, or C₁₀ alkyl-) optionally comprising olefinic bonds and heteroatoms (including halides, preferably fluoride), and
n is 50 to 100,000, 60 to 50,000, 75 to 25,000, 100 to 10,000, 125 to 7,500, 150 to 5,000, 150 to 2,500, 150 to 1,000, 175 to 900, 175 to 800, 175 to 750, 200 to 700, 200 to 650, 210 to 600, 225 to 550, or 225 to 500.

The combinations of “R¹” and “R²” or “R³” and “R⁴” in the polysiloxane are selected to provide the desired rheological and/or mechanical properties to the uncured and cured purge composition, as discussed herein. “R¹” and “R²” or “R³” and “R⁴” may be, e.g., as listed in Table 10 below upon the siloxane. In the table, an “X” represents “R¹ or R³ from [corresponding moiety in first row] and R² or R⁴ [corresponding moiety in first column].” For example, the first “X” is the combination of “R¹═CH₃” and “R²═CH₃.”

TABLE 10
R¹-R⁴

| (R¹R³/ | | | | | | | | | | |
|---|---|---|---|---|---|---|---|---|---|---|
| R²R⁴) | CH₃ | Et | Vinyl | Pr | EtF | PrF₃ | TMS | EtPh | Ph | Nph |
| CH₃ | X | | | | | | | | | |
| Et | X | X | | | | | | | | |
| Vinyl | X | X | X | | | | | | | |
| Pr | X | X | X | X | | | | | | |
| EtF | X | X | X | X | X | | | | | |
| PrF₃ | X | X | X | X | X | X | | | | |
| TMS | X | X | X | X | X | X | X | | | |
| EtPh | X | X | X | X | X | X | X | X | | |
| Ph | X | X | X | X | X | X | X | X | X | |
| Nph | X | X | X | X | X | X | X | X | X | X |

In the above table Et is CH₃CH₂—, vinyl is H₂C═CH—, EtF is CFH₂CH₂—, PrF₃ is CF₃CH₂CH₂—, TMS is (CH₃)₃Si—, EtPh is C₆H₅CH₂CH₂—, Ph is C₆H₅—, and Nph is naphthalene, i.e., C₄H₄C₆H₃—. Thus, the R¹ and R² or R³ and R⁴ in the polysiloxane, can be, for example, CH₃— and CH₃—, or CH₃— and C₆H₅—, or CH₃CH₂— and CH₃CH₂—, or C₆H₅— and C₆H₅—.

The variable “n” or “m” in the polysiloxane prior to cross-linking is selected to allow the desired flow and penetration into the device to be cleaned, and/or the desired adhesion or abstraction of contaminant residues sought to be removed from the device, as discussed herein. Typically, the variable “n” or “m” in the idealized polysiloxane prior to cross-linking can be, e.g., as listed in Table 11 below. As depicted in Table 11, an “X” represents a range “from [corresponding value in first row] to [corresponding value in first column].” For example, the first “X” in Table 11 represents the variable “n” or “m” in idealized polysiloxane prior to cross-linking wherein the value is “from 0 to 450.” Similarly, the first “X”s in the second row of Table 11 are meant to convey the variable “n” or “m” in the idealized polysiloxane prior to cross-linking having a value of from 0 to 475 and/or from 50 to 475.

Moreover, the variable “n” or “m” in the polysiloxane prior to cross-linking can have a value of 0 or more, for example, 50 or more, 75 or more, 100 or more, 150 or more, 200 or more, 250 or more, 300 or more, 350 or more, or 400 or more. Alternatively, or in addition, the variable “n” or “m” in idealized polysiloxane prior to cross-linking can have a value of 1000 or less, for example, 875 or less, 750 or less, 625 or less, 575 or less, 550 or less, 525 or less, 500 or less, 475 or less, or 450 or less. Thus, the variable “n” or “m” in idealized polysiloxane prior to cross-linking can have a value bounded by any two of the aforementioned endpoints, for example, from 0 to 1000, and the like.

TABLE 11
Variable “n” or “m” in the idealized polysiloxane

| n/m | 0 | 50 | 75 | 100 | 150 | 200 | 250 | 300 | 350 | 400 |
|---|---|---|---|---|---|---|---|---|---|---|
| 450 | X | X | X | X | X | X | X | X | X | X |
| 475 | X | X | X | X | X | X | X | X | X | X |
| 500 | X | X | X | X | X | X | X | X | X | X |
| 525 | X | X | X | X | X | X | X | X | X | X |
| 550 | X | X | X | X | X | X | X | X | X | X |
| 575 | X | X | X | X | X | X | X | X | X | X |
| 625 | X | X | X | X | X | X | X | X | X | X |
| 750 | X | X | X | X | X | X | X | X | X | X |
| 875 | X | X | X | X | X | X | X | X | X | X |
| 1000 | X | X | X | X | X | X | X | X | X | X |

The uncured purge composition has a suitable adhesion force to metal, including iron, steel, aluminum, copper, chromium, titanium, tungsten, and alloys of these, as well as to polymeric, filler, and other additive residues in devices to be cleaned such that the uncured purge composition adheres to the desired portions of a materials processing device. This adhesion can also be considered “tackiness” or “tack” which can be quantified, for example, as follows.

Using a tack test device probe made of steel, adhesive or purge composition is applied to a 19 mm flat bottom plate having a circular probe that is 5 mm in diameter (ultimately pressed against a similar circular steel plate), wherein the edge is not rounded. A rheometer is used to make the tack measurements. The uncured purge formulation is deposited in an about 0.15 mm thick layer attached to the bottom plate opposite the rheometer probe. The 0.15 mm-thick layer of uncured purge formulation, attached to a flat steel plate, is compressed for a period of 1 to 2 seconds and then pulled in tension at a release rate of 0.1 mm/s.

In keeping with an aspect of the invention, the tack can be quantified using any suitable method. Exemplary methods for quantifying the tack of the inventive compositions include, for example, loop tack, quick stick, rolling ball, and inverted probe tests.

In the inverted probe test the composition is contacted by an inverted probe at a fixed speed, contact time, and contact pressure. The tack is then measured as the maximum force need to break the resultant bond. Other tack test methods comprise measuring the force needed to separate two parallel plates containing a prescribed volume of material between the plates from a stationary position without applying any initial pressure. The peak (negative) normal force (tension) is attributable to the tack, the area under the force-time curve is attributable to adhesive or cohesive strength, the time required for the peak force to decay by 90%—a comparative measure of failure rate or time.

The components of the polymer formulation, including the relative amounts of said components, are selected such that the maximum release force of the purge composition prior to cross-linking allows the desired flow and penetration into the device to be cleaned, and/or the desired adhesion or abstraction of contaminant residues sought to be removed from the device, as discussed herein. Typically, the maximum release force of the purge composition can be, e.g., as listed in Table 12 below.

As depicted in Table 12, an “X” represents a range “from [corresponding value in first row] to [corresponding value in first column],” with units in N. For example, the first “X” (top left) represents an embodiment of the inventive purge composition wherein the maximum release force is “from 0.5 N to 4 N.” Similarly, the first two “X”s in the second row of Table 12 are meant to convey that embodiments of the inventive purge composition can have a maximum release force of from 0.5 to 5 N and/or from 0.75 to 5 N.

Moreover, the maximum release force of the purge composition prior to cross-linking can have a value of 0.5 N or more, for example, 0.75 N or more, 1 N or more, 1.25 N or more, 1.5 N or more, 1.75 N or more, 2 N or more, 2.25 N or more, 2.5 N or more, or 3 N or more. Alternatively, or in addition, the maximum release force of the purge composition prior to cross-linking can have a value of 20 N or less, for example, 17.5 N or less, 15 N or less, 12.5 N or less, 10 N or less, 8.75 N or less, 7.5 N or less, 6.25 N or less, 5 N or less, or 4 N or less. Thus, the maximum release force of the purge composition prior to cross-linking can have a value bounded by any two of the aforementioned endpoints, for example, from 0.5 to 20 N, and the like.

TABLE 12
Maximum release force of purge composition

| (N) | 0.5 | 0.75 | 1 | 1.25 | 1.5 | 1.75 | 2 | 2.25 | 2.5 | 3 |
|---|---|---|---|---|---|---|---|---|---|---|
| 4 | X | X | X | X | X | X | X | X | X | X |
| 5 | X | X | X | X | X | X | X | X | X | X |
| 6.25 | X | X | X | X | X | X | X | X | X | X |
| 7.5 | X | X | X | X | X | X | X | X | X | X |
| 8.75 | X | X | X | X | X | X | X | X | X | X |
| 10 | X | X | X | X | X | X | X | X | X | X |
| 12.5 | X | X | X | X | X | X | X | X | X | X |
| 15 | X | X | X | X | X | X | X | X | X | X |
| 17.5 | X | X | X | X | X | X | X | X | X | X |
| 20 | X | X | X | X | X | X | X | X | X | X |

The area under the force versus time plot of the purge composition prior to cross-linking is selected to allow the desired flow and penetration into the device to be cleaned, and/or the desired adhesion or abstraction of contaminant residues sought to be removed from the device, as discussed herein.

Typically, the area under the force versus time plot can be, e.g., as listed in Table 13 below. As depicted in Table 13, an “X” represents a range “from [corresponding value in first row] to [corresponding value in first column],” with units in N·s, i.e., Newtons x seconds. For example, the first “X” (top left) represents an embodiment of the inventive purge composition wherein the area under the force versus time plot of the purge composition prior to cross-linking is “from 2.5 N·s to 5 N·s.” Similarly, the first “X”s in the second row of Table 13 are meant to convey that embodiments of the inventive purge composition can have the purge composition prior to cross-linking having the area under the force versus time plot of from 2.5 N·s to 7.5 N·s and/or from 3.75 N·s To 7.5 N·s.

Moreover, the area under the force versus time plot of the purge composition prior to cross-linking can have a value of 2.5 N·s or more, for example, 3.75 N·s or more, 5 N·s or more, 6.25 N·s or more, 7.5 N·s or more, 8.75 N·s or more, 10 N·s or more, 11.25 N·s or more, 12.5 N·s or more, or 15 N·s or more. Alternatively, or in addition, the area under the force versus time plot of the purge composition prior to cross-linking can have a value of 27.5 N·s or less, for example, 25 N·s or less, 22.5 N·s or less, 20 N·s or less, 17.5 N·s or less, 15 N·s or less, 12.5 N·s or less, 10 N·s or less, 7.5 N·s or less, or 5 N·s or less. Thus, the area under the force versus time plot of the purge composition prior to cross-linking can have a value bounded by any two of the aforementioned endpoints, for example, from 2.5 to 27.5 N s, and the like.

TABLE 13
Area under the force versus time plot

| (N · s) | 2.5 | 3.75 | 5 | 6.25 | 7.5 | 8.75 | 10 | 11.25 | 12.5 | 15 |
|---|---|---|---|---|---|---|---|---|---|---|
| 5 | X | | | | | | | | | |
| 7.5 | X | X | X | X | | | | | | |
| 10 | X | X | X | X | X | X | | | | |
| 12.5 | X | X | X | X | X | X | X | X | | |
| 15 | X | X | X | X | X | X | X | X | X | |
| 17.5 | X | X | X | X | X | X | X | X | X | X |
| 20 | X | X | X | X | X | X | X | X | X | X |
| 22.5 | X | X | X | X | X | X | X | X | X | X |
| 25 | X | X | X | X | X | X | X | X | X | X |
| 27.5 | X | X | X | X | X | X | X | X | X | X |

The polymer formulation, before curing, has a tensile strength in a range of from 5 to 20 N/mm², preferably 7 to 15 N/mm², more preferably 8 to 12 N/mm². For example, the polymer formulation before curing can have a tensile strength of 5 N/mm² or more, for example, 6 N/mm², 7 N/mm², 8 N/mm², 9 N/mm², 10 N/mm², 11 N/mm², 12 N/mm², 13 N/mm², 14 N/mm², 15 N/mm², 16 N/mm², 17 N/mm², 18 N/mm², 19 N/mm², 20 N/mm², or a range bounded by any two of the foregoing values.

In keeping with an aspect of the invention, the inventive polymer formulation, when cured, has a maximum elongation at break of 300% or more, for example, 325% or more, 350% or more, 375% or more, 400% or more, 425% or more, 450% or more, 475% or more, or 500% or more. Alternatively, or in addition, the inventive polymer formulation, when cured, has a maximum elongation at break of 750% or less, for example, 725% or less, 700% or less, 675% or less, 650% or less, 625% or less, 600% or less, 575% or less, 550% or less, or 525% or less. Thus, any two of the aforementioned endpoints can be used to define a close-ended range or can be used single to define an open-ended range. For example, the amount of the inventive polymer formulation can have a maximum elongation at break of 300% to 750%, 325% to 725%, 350% to 700%, 375% to 675%, 400% to 650%, 425% to 625%, 450% to 600%, 475% to 575%, or 500% to 550%, and the like.

The cured purge composition may have a melt flow rate (MFR), according to ASTM D1238-04 at 190° C./2.16 kg of less than 0.1 g/10 min, less than 0.01 g/10 min, less than 0.001 g/10 min, less than 0.0001 g/10 min, or even 0 g/10 min.

The cured purge composition, relative to the pre-curing purge composition, has a decrease in tackiness of at least 50%, at least 75%, at least 85%, at least 90%, at least 95%, at least 97.5%, up to 100%, i.e., complete elimination of tackiness, as measured by the tack test device described above, under the same temperature conditions.

The Shore A hardness of the cured purge composition should be above 7.5, and generally may be in a range of from 15 to 40, is selected to optimize the take-up of residues desired to be clean, and/or to allow appropriate shearing, fracture, and/or pulverization of the cured purge composition to allow expulsion, as discussed herein. Typically, the Shore A hardness can be, e.g., as listed in Table 14 below.

As depicted in Table 14, an “X” represents a unitless range “from [corresponding value in first row] to [corresponding value in first column].” For example, the first “X” (top left) represents an embodiment of the invention purge composition wherein the Shore A hardness of the cured purge composition is “from 7.5 to 50.” Similarly, the first “X”s in the second row of Table 14 are meant to convey that embodiments of the inventive purge composition can have a Shore A hardness post-curing of from 7.5 to 17.5 and/or 10 to 20.

Moreover, the cured purge composition can have a Shore A hardness of 7.5 or more, for example, 10 or more, 11.25 or more, 12.5 or more, 13.75 or more, 15 or more, 16.25 or more, 17.5 or more, 20 or more, or 22.5 or more. Alternatively, or in addition, the cured purge composition can have a Shore A hardness of 50 or less, for example, 40 or less, 35 or less, 32.5 or less, 30 or less, 27.5 or less, 25 or less, 22.5 or less, 20 or less, or 17.5 or less. Thus, the cured purge composition can have a Shore A hardness bounded by any two of the aforementioned endpoints, for example, from 7.5 to 50.

TABLE 14
Shore A hardness of cured purge composition

| | 7.5 | 10 | 11.25 | 12.5 | 13.75 | 15 | 16.25 | 17.5 | 20 | 22.5 |
|---|---|---|---|---|---|---|---|---|---|---|
| 17.5 | X | X | X | X | X | X | X | | | |
| 20 | X | X | X | X | X | X | X | X | | |
| 22.5 | X | X | X | X | X | X | X | X | X | |
| 25 | X | X | X | X | X | X | X | X | X | X |
| 27.5 | X | X | X | X | X | X | X | X | X | X |
| 30 | X | X | X | X | X | X | X | X | X | X |
| 32.5 | X | X | X | X | X | X | X | X | X | X |
| 35 | X | X | X | X | X | X | X | X | X | X |
| 40 | X | X | X | X | X | X | X | X | X | X |
| 50 | X | X | X | X | X | X | X | X | X | X |

The invention also provides a method of cleaning one or more residues from an interior of a material processing device, the method comprising introducing a cleaning composition, in fluid form, into the interior of the device so as to at least partially take up the residue into the cleaning composition, the interior being inaccessible to an operator without at least partial disassembly; curing the cleaning composition within the interior of the device, thereby forming a cross-linked and/or thermoset material, at least partially containing the residue(s), within the device; and operating the device to thereby break up the cross-linked and/or thermoset material and render the cross-linked and/or thermoset material and the residue expellable from the device. The operating of the devices generally fractures and/or pulverizes the cured purge composition comprising the residue(s).

A device cleaned in accordance with the invention may be any type with a sufficient mechanical agitator, e.g., stirrer, screw, or the like, to break up the solidified (cured) purge compound, wherein access to the internal space or space to be clean is sufficiently difficult to gain. Examples of devices suitable for treatment with the purge composition according to the invention are a mixer, a single screw extruder, a twin screw extruder, a kneader, or a mill, an elastomer extruder, a compounder, a compounding extruder, and reclaim extruder.

The purge composition may reside in a device for any suitable time (e.g., dwell time). As understood, the dwell time typically is inversely related to the dwell temperature such that when the dwell temperature is higher, the dwell time will be shorter. In keeping with an aspect of the invention, the dwell time is long enough to facilitate the removal of residue and the cleaning of the device. Typically, the dwell time of the purge composition in a device may be from 1 to 30 minutes, 1.5 to 25 minutes, 2 to 20 minutes, 2.5 to 15 minutes, 3 to 12.5 minutes, 3.5 to 10 minutes, or 5 to 10 minutes.

In accordance with an aspect of the invention, the polymer formulation is cured to form a thermoset material. The curing of the polymer formulation occurs at any suitable time during the dwell time. Typically, the polymer formulation is cured near the end of the dwell time, e.g., after 50%, 60%, 75%, 85%, 90%, or 95% of the dwell time.

The polymer formulation may be cured at any suitable temperature. Typically, the polymer formulation is cured at a temperature above 50° C., or at a temperature in a range of from 50 to 250° C., 60 to 200° C., 65 to 175° C., 70 to 150° C., 75 to 140° C., 80 to 130° C., 85 to 125° C., or 90 to 115° C.

### EMBODIMENTS

(1) In embodiment (1) is presented a purge composition, comprising a polymer formulation which is tacky and suitable to cross-link and/or cure to become less tacky, at least 50% of solids of the polymer formulation comprising a polysiloxane, polyurethane, acrylate resin, epoxy resin, melamine resin, formaldehyde resin, or a mixture of two or more of any of these; and a curing catalyst suitable to cure the polymer formulation, wherein the composition is suitable to cross-link and/or cure at within 0.1 to 120 minutes at a temperature in a range of from 0 to 450° C. within a device into which the composition is injected.

(2) In embodiment (2) is presented the composition of embodiment (1), wherein the polymer formulation is thermosetting.

(3) In embodiment (3) is presented the composition of any one of embodiments (1) or (2), wherein the polymer formulation comprises a polysiloxane with a M_{w} in a range of from 15 to 45 kDa and a polydispersity index (PDI) in the range of from 3 to 4.5.

(4) In embodiment (4) is presented the composition of any one of embodiments (1)-(3), wherein the polymer formulation comprises a polysiloxane with a M_{w} in a range of from 15 to 45 kDa and a PDI in the range of from 1.8 to 3.

(5) In embodiment (5) is presented the composition of any one of embodiments (1)-(4), wherein the polymer formulation comprises a first component which cures at a temperature in a range of from 15 to 30° C. within 10 minutes.

(6) In embodiment (6) is presented the composition of any one of embodiments (1)-(5), wherein the polymer formulation comprises a second component which cures at a temperature in a range of from 150 to 180° C. within 10 minutes.

(7) In embodiment (7) is presented the composition of any one of embodiments (1)-(6), wherein the polymer formulation cures at a temperature in a range of from 70 to 100° C. within a period of 3 to 10 minutes.

(8) In embodiment (8) is presented the composition of any one of embodiments (1)-(7), wherein the polymer formulation, excluding fillers, has a viscosity of 10 to 30 Pa·s at 25° C.

(9) In embodiment (9) is presented the composition of any one of embodiments (1)-(8), wherein the polymer formulation comprises a filler, the filled polymer having a viscosity of 10 to 30 Pa·s at 25° C.

(10) In embodiment (10) is presented the composition of any one of embodiments (1)-(9), wherein the polymer formulation has a viscosity of at most 100 Pa·s at 25° C., preferably 75 Pa·s, more preferably in a range of from 20 to 60 Pa·s.

(11) In embodiment (11) is presented the composition of any one of embodiments (1)-(10), wherein the polymer formulation, when cured, has a maximum elongation at break of 500%.

(12) In embodiment (12) is presented the composition of any one of embodiments (1)-(11), wherein the polymer formulation, before curing, has a tensile strength in a range of from 5 to 20 N/mm², preferably 7 to 15 N/mm², more preferably 8 to 12 N/mm².

(13) In embodiment (13) is presented the composition of any one of embodiments (1)-(12), wherein the polymer formulation further comprises water.

(14) In embodiment (14) is presented the composition of any one of embodiments (1)-(13), wherein the solids of the polymer formulation are at least 50 wt. % of a total weight of the composition, preferably at least 75 wt. %, more preferably 80 to 95 wt. %.

(15) In embodiment (15) is presented the composition of any one of embodiments (1)-(14), suitable for use without an organic solvent.

(16) In embodiment (16) is presented the composition of any one of embodiments (1)-(15), which removes 75% or more of residues in the device without requiring a filler.

(17) In embodiment (17) is presented the composition of any one of embodiments (1)-(16), suitable for use without a filler.

(18) In embodiment (18) is presented the composition of any one of embodiments (1)-(17), wherein the catalyst comprises a platinum-containing curing catalyst, tin-containing curing catalyst, and/or a peroxide.

(19) In embodiment (19) is presented a method of cleaning a residue from an interior of a material processing device, the method comprising introducing a cleaning composition, in fluid form, into the interior of the device so as to at least partially take up the residue into the cleaning composition, the interior being inaccessible to an operator without at least partial disassembly; curing the cleaning composition within the interior of the device, thereby forming a thermoset material, at least partially containing the residue, within the device; and operating the device to thereby break up the thermoset material and render the thermoset material and the residue expellable from the device.

(20) In embodiment (20) is presented the method of embodiment (19), wherein the cleaning composition is the purge composition of any one of embodiments (1)-(18).

### EXAMPLES

The following examples further illustrate the invention but, of course, should not be construed as in any way limiting its scope.

### Comparative Example 1

Before introducing into the feeding zone, a latex (LITEX™ NX 1130 latex from Synthomer (London, UK), aqueous, colloidal dispersion of a carboxylated butadiene-acrylonitrile copolymer; 48% solids content; curing at 100-130° C.) was filled with chalk to get a free-flow, viscous paste. The unfilled latex could infiltrate the screw sealing. After application, pigments in the device were wetted by short on/off starts. After few minutes, the latex coagulated (rubber separated from water phase) by mild conditions (about 50° C.) in the feeding zone. After starting the extruder, the coagulated rubber could not transport completely off the feeding zone. The texture of the coagulated latex was like chewing gum. Accordingly, it was concluded that such latexes are not suitable because crosslinking is not possible at such low temperatures in the feeding zone, and the tensile strength of uncured latexes is too low.

### Example 1—Low Viscosity Rubber (LVR) Type 1

This example demonstrates a purge composition comprising a polymer formulation comprising a polysiloxane and a curing catalyst in accordance with an embodiment of the invention. This example also demonstrated a method of cleaning in accordance with an embodiment of the invention.

A polysiloxane formulation (dual-component-polysiloxane LVR, platinum catalyzed (addition reaction), PROVIL™ LIGHT CD 2 dental casting from Heraeus Kulzer (Hanau, Germany); 45% solids content; curing at room temperature/3-5 min) was injected into the feeding zone of a dual-component-gun with astatic mixer. After application, pigments in the device were wetted by short on/off starts. Vulcanization at room-temperature, i.e., in a range of from 23-28° C., finished after 5 minutes. After vulcanization, the pigments from the feeding zone were completely embedded in the rubber phase. By starting the extruder the vulcanized rubber could be completely extruded. Regarding the low vulcanization temperature of about 25° C., it was not possible to transport an adequate quantity of LVR into the first third of the extruder. After contact with the heated part of the extruder, this LVR vulcanized spontaneously, making it impossible to remove pigments out of this zone. It was concluded that the LVR silicone system, PROVIL™ LIGHT CD 2 polysiloxane, is excellent to remove contamination in the feeding zone. To remove contamination in the heated zones, a system with higher vulcanization temperature is needed.

### Example 2—Low Viscosity Rubber (LVR) Type 2

This example demonstrates a purge composition comprising a polymer formulation comprising a polysiloxane and a curing catalyst in accordance with an embodiment of the invention. This example also demonstrated a method of cleaning in accordance with an embodiment of the invention.

After mixing two components of a LVR polysiloxane system (dual-component-polysiloxane LVR ELASTOSIL™ LR 3003/40 from Wacker silicones; curing at 165° C./5 min; viscosity 840 Pa·s), the system was introduced into the feeding zone of an extruder by using a syringe. The extruder was started and the still reactive LVR system was transported into the heated extruder zone. The extruder was then stopped. To make the vulcanization possible in the feeding zone, the cooling circuit in the feeding zone was stopped. After about 10 minutes, the LVR system was cured and the vulcanized rubber was extruded. It was concluded that good cleaning resulted in the feeding zone and in the first third of the extruder.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A purge composition, comprising:
a polymer formulation which is tacky and suitable to cross-link and/or cure to become less tacky, at least 50% of solids of the polymer formulation comprising a polysiloxane, polyurethane, acrylate resin, epoxy resin, melamine resin, formaldehyde resin, or a mixture of two or more of any of these; and
a curing catalyst suitable to cure the polymer formulation,
wherein the composition is suitable to cross-link and/or cure at within 0.1 to 120 minutes at a temperature in a range of from 0 to 450° C. within a device into which the composition is injected.

2. The composition of claim 1, wherein the polymer formulation is thermosetting.

3. The composition of claim 1, wherein the polymer formulation comprises a polysiloxane with a M_{w} in a range of from 15 to 45 kDa and a polydispersity index in the range of from 3 to 4.5.

4. The composition of claim 1, wherein the polymer formulation comprises a polysiloxane with a M_{w} in a range of from 15 to 45 kDa and a polydispersity index in the range of from 1.8 to 3.

5. The composition of claim 1, wherein the polymer formulation comprises a first component which cures at a temperature in a range of from 15 to 30° C. within 10 minutes.

6. The composition of claim 1, wherein the polymer formulation comprises a second component which cures at a temperature in a range of from 150 to 180° C. within 10 minutes.

7. The composition of claim 1, wherein the polymer formulation cures at a temperature in a range of from 70 to 100° C. within a period of 3 to 10 minutes.

8. The composition of claim 1, wherein the polymer formulation, excluding fillers, has a viscosity of 10 to 30 Pa·s at 25° C.

9. The composition of claim 1, wherein the polymer formulation comprises a filler, and the polymer formulation comprising the filler has a viscosity of 10 to 30 Pa·s at 25° C.

10. The composition of claim 1, wherein the polymer formulation has a viscosity of at most 100 Pa·s at 25° C.

11. The composition of claim 1, wherein the polymer formulation, when cured, has a maximum elongation at break of at least 300%.

12. The composition of claim 1, wherein the polymer formulation, before curing, has a tensile strength in a range of from 5 to 20 N/mm².

13. The composition of claim 1, wherein the polymer formulation further comprises water.

14. The composition of claim 1, wherein the solids of the polymer formulation are at least 50 wt. % of a total weight of the composition.

15. The composition of claim 1, suitable for use without an organic solvent.

16. The composition of claim 1, which removes 75% or more of residues in the device without requiring a filler.

17. The composition of claim 1, suitable for use without a filler.

18. The composition of claim 1, wherein the curing catalyst comprises a platinum-containing curing catalyst, tin-containing curing catalyst, and/or a peroxide.

19. A method of cleaning a residue from an interior of a material processing device, the method comprising:
introducing a cleaning composition, in fluid form, into the interior of the device so as to at least partially take up the residue into the cleaning composition, the interior being inaccessible to an operator without at least partial disassembly;
curing the cleaning composition within the interior of the device, thereby forming a thermoset material, at least partially containing the residue, within the device; and
operating the device to thereby break up the thermoset material and render the thermoset material and the residue expellable from the device.

20. The method of claim 19, wherein the cleaning composition is the purge composition of claim 1.
